(19) United States
(12) Patent Application Publication
(10) Pub. No.: US 2017/0116465 A1
(43) Pub. Date: Apr. 27, 2017

(54) VIDEO PROCESSING METHOD AND SYSTEM, VIDEO PLAYER AND CLOUD SERVER

(71) Applicants: Le Holdings (Beijing) Co., Ltd., Beijing (CN); Lemobile Information Technology (Beijing) Co., Ltd., Beijing (CN)

(72) Inventors: Jin MA, Beijing (CN); Xiong TANG, Beijing (CN)

(21) Appl. No.: 15/247,043

(22) Filed: Aug. 25, 2016

Related U.S. Application Data
(63) Continuation of application No. PCT/CN2016/085011, filed on Jun. 6, 2016.

(30) Foreign Application Priority Data
Oct. 26, 2015 (CN) 201510702093.7

(51) Int. Cl. G06K 9/00; G06F 17/30; G11B 27/22

(52) U.S. Cl. CPC G06K 9/00288; G06K 9/00718; G11B 27/22; G06F 17/30793

(57) ABSTRACT

The present disclosure provides a video processing method and a video processing system, a video player and a cloud server, wherein the video processing method includes: receiving a video locating request carrying a selected human face picture sent by a user through a man-machine interface module; acquiring video information in a video corresponding to the selected human face picture in the video locating request, the video information including the identification of the selected human face picture and the information of at least one video segment of the selected human face picture; and displaying the video information corresponding to the selected human face picture.

### CROSS REFERENCE TO RELATED APPLICATIONS

This application is national phase application of PCT international application PCT/CN2016/085011, filed Jun. 6, 2016, which claims priority to Chinese Patent Application No. 2015107020937, filed Oct. 26, 2015, the entire contents of which are incorporated herein by reference.

### TECHNICAL FIELD

The present disclosure relates to the field of video processing technologies, and more particularly, to a video processing method and a video processing system, a video player and a cloud server.

### BACKGROUND

In recent years, with the development of science and technology, a wide variety of video have been emerged in order to provide users with a richer cultural life and services. In order to facilitate the users to view, the users may video interested video programs thereof through such a terminal like a computer or a mobile phone by a manner of downloading or online viewing.

In the prior art, with the increasing video programs, in order to facilitate the users to quickly find out the approximate frame of each time period in the video, some clients may provide the users with video thumbnails, and the users may know the frame conditions of the video in each time period through the video thumbnails in advance; however, when the video is too long, there will be more thumbnails, which cause difficulty to the users to quickly locate video segments interested thereof, which may bring a poor user experience to the viewers. In order to facilitate the users to quickly locate the video segments interested thereof from the video, some clients also provide story tips of partial time periods, so that the users may quickly locate the video segments interested thereof with reference to the video thumbnails and story tips.

However, during the process of implementing the present disclosure, the inventors have found that the users need to operate manually to locate the video segments interested thereof with reference to the video thumbnails and story tips in the prior art, resulting in lower video locating efficiency.

### SUMMARY

The embodiments of the present disclosure provide a video processing method and a video processing system, a video player and a cloud server so as to overcome the defect of lower video locating efficiency in the prior art, implement to locate all the video segments of a determined human face in a video and improve the locating processing efficiency of videos.

The embodiment of the present disclosure provides a video processing method, including:

receiving a video locating request carrying a selected human face picture sent by a user through a man-machine interface module;

acquiring video information in a video corresponding to the selected human face picture in the video locating request, the video information including the identification of the selected human face picture and the information of at least one video segment of the selected human face picture; and

displaying the video information corresponding to the selected human face picture.

The embodiment of the present disclosure also provides a video processing method, including:

receiving a video locating request carrying a selected human face picture sent by a video player, the video locating request being sent by a user through a man-machine interface module and received by the video player;

acquiring the video information corresponding to the selected human face picture from an established human face classification database, the video information including the identification of the selected human face picture and the information of at least one video segment of the selected human face picture; and

sending the video information corresponding to the selected human face picture to the video player for the video player to display the video information corresponding to the selected human face picture to the user.

The embodiment of the present disclosure also provides a video player, including:

a receiving module configured to receive a video locating request carrying a selected human face picture sent by a user through a man-machine interface module;

an acquisition module configured to acquire video information in a video corresponding to the selected human face picture in the video locating request, the video information including the identification of the selected human face picture and the information of at least one video segment of the selected human face picture; and

a display module configured to display the video information corresponding to the selected human face picture.

The embodiment of the present disclosure also provides a cloud server, including:

a receiving module configured to receive a video locating request carrying a selected human face picture sent by a video player, the video locating request being sent by a user through a man-machine interface module and received by the video player;

an acquisition module configured to acquire the video information corresponding to the selected human face picture from an established human face classification database, the video information including the identification of the selected human face picture and the information of at least one video segment of the selected human face picture; and

a sending module configured to send the video information corresponding to the selected human face picture to the video player for the video player to display the video information corresponding to the selected human face picture to the user. The embodiment of the present disclosure also provides a video playing system, wherein the video playing system includes a video player and a cloud server, the video player and the cloud server are in communication connection, the video player as described above is employed as the video player, and the cloud server as described above is employed as the cloud server.

The video processing method, the video processing system, the video player and the cloud server according to the embodiments of the present disclosure acquire the video information in the video corresponding to the selected human face picture in the video locating request, and display the video information corresponding to the selected human face picture through receiving the video locating request carrying the selected human face picture sent by the user through the man-machine interface module. The technical solution of the embodiments of the present disclosure may be employed to remedy the defect of low video locating efficiency in the prior art caused by that all the video segments of a certain determined human face cannot be located completely and implement to locate all the video information of one selected human face picture in the video, and has a very high video locating efficiency. Moreover, employing the technical solution of the embodiments of the present disclosure facilitates users to view the all the performances of an actor corresponding to the selected human face picture in the video, and the user experience degree is very good.

### BRIEF DESCRIPTION OF THE DRAWINGS

In order to explain the technical solutions in the embodiments of the present disclosure or in the prior art more clearly, the drawings used in the descriptions of the embodiments or the prior art will be simply introduced hereinafter. It is apparent that the drawings described hereinafter are merely some embodiments of the present disclosure, and those skilled in the art may also obtain other drawings according to these drawings without going through creative work.

FIG. 1 is a flow chart of one embodiment of a video processing method according to the embodiment of the present disclosure;

FIG. 2 is a PTS scattergram of a human face corresponding to a certain human face identification in the embodiment of the present disclosure;

FIG. 3 is a flow chart of another embodiment of the video processing method according to the embodiment of the present disclosure;

FIG. 4 is a flow chart of a further embodiment of the video processing method according to the embodiment of the present disclosure;

FIG. 5 is a flow chart of still another embodiment of the video processing method according to the embodiment of the present disclosure;

FIG. 6 is a flow chart of yet further embodiment of the video processing method according to the embodiment of the present disclosure;

FIG. 7 is a structure diagram of one embodiment of a video player according to the embodiment of the present disclosure;

FIG. 8 is a structure diagram of another embodiment of the video player according to the embodiment of the present disclosure;

FIG. 8 is a structure diagram of further embodiment of the video player according to the embodiment of the present disclosure;

FIG. 10 is a structure diagram of still another embodiment of the video player according to the embodiment of the present disclosure;

FIG. 11 is a structure diagram of one embodiment of a cloud server according to the embodiment of the present disclosure;

FIG. 12 is a structure diagram of another embodiment of the cloud server according to the embodiment of the present disclosure; and

FIG. 13 is a structure diagram of an embodiment of a video playing system according to the embodiment of the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the present disclosure without going through creative efforts shall all fall within the protection scope of the present disclosure.

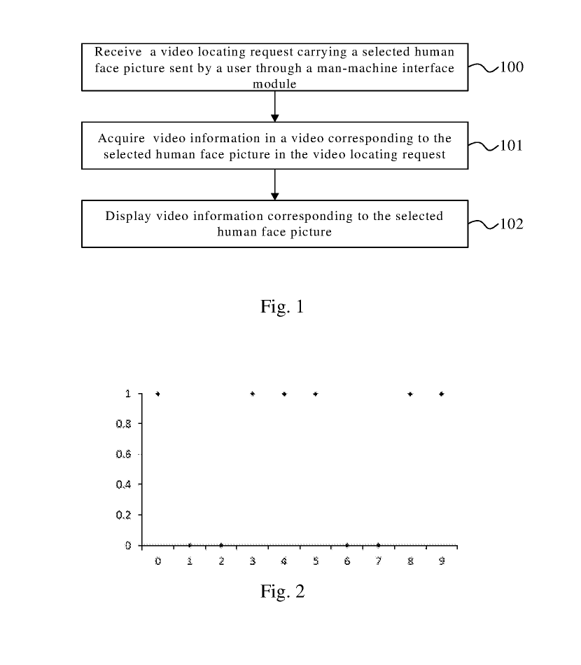

FIG. 1 is a flow chart of one embodiment of a video processing method according to the present disclosure. As shown in FIG. 1, the video processing method of the embodiment may particularly include the following steps.

In step 100, a video locating request carrying a selected human face picture sent by a user through a man-machine interface module is received.

In the embodiment, the technical solution of the present disclosure is described at the side of the video player. The video player is namely a client of a video processing system. The video player may be installed on such a mobile terminal like a mobile phone, a tablet, etc; and may also be installed on a non-mobile terminal (i.e. a common terminal) like a computer, etc. To be specific, the client is interacted with the user, and the video player receives the video locating request carrying the selected human face picture sent by the user through the man-machine interface module, wherein the man-machine interface module may be a keyboard, a stylus or an information detection and receiving module of a touch screen, or the like. For example, when the user selects the selected human face on the touch screen through fingers or the stylus, and clicks a button corresponding to sending the video locating request, the information detection and receiving module of the touch screen may detect the video locating request sent by the user, and acquire the selected human face picture carried in the video locating request. For example, the selected human face picture selected by the user in the embodiment may be the clear human face picture of a certain actor selected by the user, or the human face of the actor in a video screen shot. Anyway, it is required that the human face included in the selected human face picture is clear enough to facilitate recognition.

In step 101, video information in a video corresponding to the selected human face picture in the video locating request is acquired.

The video information of the embodiment includes the identification of the selected human face picture and the information of at least one video segment of the selected human face picture, for may further include the selected human face picture. Because the video is composed of various video segments in series by various actors, all the video information corresponding to the selected human face picture in the video locating request may be acquired in the embodiment, wherein each video information may include the identification of the selected human face picture and the information of at least one video segment, and wherein the identification of the selected human face picture is configured to uniquely identify the selected human face picture in the video, and may be the name or stage name of the corresponding actor; or, other identification (Identification; ID) may be used to uniquely identify the selected human face picture when the name or stage name of the actor corresponding to the selected human face picture is not unique in the video. The video segment is a video segment of the selected human face picture appearing in the video; one video segment of the selected human face picture appearing in the video is namely one video segment; and the information of at least one video segment refers to all the video segments of the selected human face picture appearing in the video. For example, the information of at least one video segment of the embodiment may include the starting and ending time of each video segment, i.e., the starting time and the ending time of the video segment.

In step 102, the video information corresponding to the selected human face picture is displayed.

For example, the video information corresponding to the selected human face picture may be specifically displayed on an interface of the video player, thus completing locating the video of the selected human face picture. The user may select to view the video of the selected human face picture located in the video player according to the video information of the selected human face picture displayed. For example, the video processing method of the embodiment may be applied to the locating of all the video information of any actor in a video program to facilitate the user to view all the performances of the actor in the video.

The video processing method of the embodiment acquires the video information in the video corresponding to the selected human face picture in the video locating request, and displays the video information corresponding to the selected human face picture through receiving the video locating request carrying the selected human face picture sent by the user through the man-machine interface module. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, so that the user experience degree is also very good.

Further optionally, on the basis of the technical solution of the foregoing embodiment, the step 101 of “acquiring the video information in the video corresponding to the selected human face picture in the video locating request” may specifically include: acquiring the video information corresponding to the selected human face picture from an established human face classification database.

To be specific, the human face classification database is established at the side of a client of a video playing system, i.e., the video player. In this way, when no network connection exists between the video player and a cloud server, one end of the video player may also perform video processing of the embodiment independently.

Further optionally, the video processing method of the embodiment, before the “acquiring the video information corresponding to the selected human face picture from the established human face classification database”, may further include: establishing the human face classification database. For example, the human face classification database may include a plurality of human face identifications and the video information in the video corresponding to the human face that is corresponding to each human face identification. For example, the video information may include the starting and ending time of each video segment of the human face in the video.

Further optionally, the “establishing the human face classification database” in the foregoing embodiment may specifically include the following steps.

(1) Each frame of video in the video is decoded and a group of images are obtained.

The video is composed of various frames of images in series, while decoding each frame of images may obtain corresponding images. In the embodiment, it is illustrated by taking an RGB image as the image obtained via decoding for example. Decoding all the frames of videos in the video may obtain a group of RGB images.

(2) Human face detection is performed on each image in the group of images, and the human face in each image and the presentation time stamp (Presentation Time Stamp; PTS) of the human face is acquired.

A human detection algorithm is used on each RGB image in the group of RGB images obtained in step (1) to detect the human face. When detecting that the RGB image includes a human face, the human face in the RGB image and the PTS of the RGB image in the video playing are acquired.

(3) A human face time stamp database is generated according to the human face and the PTS of the human face.

The human face time stamp database is generated according to the human face and the PTS of each human face obtained through the human face detection in step (2). That is, the human face time stamp database includes the human face and the PTS of each human face in the video. The human face time stamp database is based on the time and saves the human faces detected from the image including the human faces corresponding to each moment. Because a video is relatively long and more images will be decoded; it is provided that the duration is 90 min, and the frame rate is 30, then 162000 (90*60*30) images need to be detected in total. Such a calculation amount will bring a larger calculation burden and a storage burden of the human face time stamp database. Therefore, in practical application, the sampling frequency may be changed when performing the human face detection in step (2) in view that the frame changes a little in a short time, for example, the human face of one image is scanned in every 10 frames, then it only needs to scan three images in each second, and 16200 (90*60*3) images need to be detected in total.

(4) All the human faces in the human face time stamp database are classified according to each human face identification so that the human faces belonging to the same person correspond to the same human face identification.

To be specific, all the human faces in the human face time stamp database obtained in step (3) may include the human face of a plurality of actors, wherein some human faces are the human faces of a certain actor in different PTS. In the step, the human faces may be classified according to the human face identification, for example, each human face in the human face time stamp database may be recognized according to a chronological PTS order; for example, a human face identification may be set for the first human face, wherein the human face identification may be inputted by the user through the man-machine interface module, which may be, for example, the name or stage name of the actor corresponding to the human face, or other human face ID; moreover, the human face identification, the human face, and the PTS of the human face are stored. Then the second human face in the human face time stamp database is recognized according to the PTS order, and the human face is judged whether to belong to the same person as that of the human face stored through a characteristic value matching algorithm; if yes, then the identification of the human face is set as a stored human face identification so that the human faces belonging to the same person correspond to the same human face identification. If the two do not belong to the same person, then a new human face identification is set and so on, so that all the human faces in the human face time stamp database may be classified according to each human face identification, so that the human faces belonging to the same person correspond to the same human face identification.

(5) The information of various video segments corresponding to the human face identification is estimated according to the PTS of the human face corresponding to each human face identification, the video segment information including the starting and ending time of the video segment.

All the human faces in the human face time stamp database may be classified according to each human face identification according to the processing in step (4). Then, continuous PTS corresponding to the human face identification may be determined according to the PTS of the human face corresponding to each human face identification in the embodiment. Because the video segment of the human face needs the human face to appear in continuous PTS, the continuous video segments of the human face may be determined according to the continuous PTS corresponding to the human face identification, so that the information of various video segments of the human face corresponding to the human face identification, i.e., the starting and ending time of the video segment, may be estimated. For example, FIG. 2 is a PTS scattergram of a human face corresponding to a certain human face identification in the embodiment of the present disclosure. Wherein, the PTS is an X-coordinate, the probability of appearance of the human face corresponding to the human face identification is a Y-coordinate, 0 represents that the human face does not appear, while 1 represents that the human face does appear. It may be seen from FIG. 2 that a period of time composed of the PTS having a longitudinal axis value of 1 and corresponding to those densest points, for example, from the time period 3 to the time period 5, may be deemed to satisfy the conditions for the human face to appear. The point corresponding to the longitudinal axis value of 1 in FIG. 2 may be divided into a plurality of segments through a segmentation algorithm, wherein each segment represents a video segment that the actor corresponding to the point appears intensively. Moreover, a segment having few PTS points, i.e., an extremely short video segment, may be discarded. For example, the video segment information as shown in Table 1 below may be obtained through the human face scattergram in FIG. 2.

TABLE 1

| Segment | Starting and ending time |
|---|---|
| 1 | 3 s-5 s |
| 2 | 8 s-9 s |

(6) The human face classification database is established according to the information of various video segments corresponding to various human face identifications.

The human face classification database is established according to each human face identification obtained above and the information of various video segments corresponding to each human face identification, wherein the human face classification database includes each human face identification, and the starting and ending time of the human face in each video segment of the video corresponding to each human face identification. In this way, it is very convenient to perform video locating according to each human face in the video in the human face classification database.

For example, the core structure body of the human face classification database of the embodiment may be represented using the following manner:

typedefstruct_humanFaceData
{
int human face _id; //human face ID
char* face_name; //name of character corresponding to human face[*}
double** face_timestamp; //starting and ending time of video segment
int number_appear; //number of video segments
float penrcent_appear; // probability of appearance of human face
}humanFaceData;
typedef struct _humanFaceDataSet
{
int number_face; //valid number of human face<= N
humanFaceData* human_face_data; //segmentation data corresponding to all the human
face
int SOURCE_ID; //data generation source: cloud server or video player, i.e., client
}humanFaceDataSet;

In the embodiment, the technical solution of the present disclosure is described at the side of the video player, i.e., a client of a video playing system. In practical application, the human face classification database may also be arranged at the side of the cloud server. Please refer to the records in the subsequent embodiments for details.

Further optionally, on the basis of the technical solution of the foregoing embodiment, the method, after the step of “establishing the human face classification database according to the information of various video segments corresponding to each human face identification”, further includes: sorting each human face identification in the human face classification database according to the probability of appearance in the video in a descending order.

To be specific, each human face identification in the human face classification database is sorted according to the probability of appearance in the video in a descending order and the probability distribution table of the human faces corresponding to each human face identification is obtained, wherein the leading actors and supporting actors in the video may be directly determined according to the probability distribution table. Optionally, the human faces with a few number of appearance may also be discarded according to the probability of appearance of the human faces corresponding to each human face identification; for example, the human faces with a tiny probability may possibly be crowds, and the probability of the human faces being located by the user is tiny; therefore, the human faces having a tiny probability may be discarded at this moment to save the memory space in the human face classification database.

Further optionally, the method, after the step of “sorting each human face identification in the human face classification database according to the probability of appearance in the video in a descending order” and before the step 100 “the receiving the video locating request carrying the selected human face picture sent by the user through the man-machine interface module” in the foregoing embodiment, further includes”: displaying the human face pictures corresponding to the top N human face identifications in the human face classification database, the N being an integer more than or equal to 1.

The top N in the embodiment refer to the N human face identifications among the various human face identification according to the probability of appearance in the video in a descending order. The N human face identifications are namely the relatively important roles in the video, and the probability of actors playing the important roles being located by the user is higher. Therefore, the video player may display the human face pictures corresponding to each human face identification in the top N human face identifications having a higher probability of appearance; in this way, the user may select one human face from the N human faces as the selected human face picture to locate the video of the selected human face picture. Therefore, the selected human face picture in the step 100 of “receiving the video locating request carrying the selected human face picture sent by the user through the man-machine interface module” in the foregoing embodiment may be selected by the user from the human face pictures corresponding to the N human face identifications. To be specific, the user may select one from the N human faces to initiate the video locating request through the man-machine interface module. Moreover, the selected human face picture in the step 100 of “receiving the video locating request carrying the selected human face picture sent by the user through the man-machine interface module” in the foregoing embodiment may also be inputted by the user through the man-machine interface module; for example, the user knows that a certain actor participates in acting in the video, one image including the selected human face picture of the actor may be downloaded from the network to initiate a video locating request in case of locating all the video segments of the actor in the video. Or, the user may also get the image including the selected human face picture of the actor through a manner of photographing and initiates the video locating request

According to all the solutions of the foregoing embodiment, the human face classification database is established at the side of the client of the video playing system, i.e., the side of the video player, and then video processing is performed. This solution requires that when the client cannot be connected to the cloud server, the functional modules that execute to establish the foregoing human face classification database may be deployed in an engine of the video player, and corresponding interfaces are provided at a native layer and a Java layer for the video player to invoke while locally executing corresponding functions.

It should be noted that a large number of resources need to be consumed while placing the human face classification database at one end of the video player and executing corresponding functions; therefore, the human face classification database may also be sent to the cloud server optionally for the cloud server to store the human face classification database after a communication connection is established between the video player and the cloud server after the step of “establishing the human face classification database” in the foregoing embodiment; moreover, the video information of a certain selected human face picture is located at the side of the cloud server in a subsequent video locating request.

For example, further optionally, the step 101 of “acquiring the video information in the video corresponding to the selected human face picture in the video locating request” in the foregoing embodiment may specifically include the following steps.

(A) The video locating request carrying the selected human face picture is sent to the cloud server.

(B) The video information sent by the cloud server is received, the video information being acquired by the cloud server from the human face classification database established in the cloud server according to the selected human face picture.

In the embodiment, it is illustrated by taking the video locating request performed at the side of the cloud server for example. After the video player receives the video locating request carrying the selected human face picture sent by the user through the man-machine interface module, the video player sends the video locating request carrying the selected human face picture to the cloud server. Then, the cloud server acquires the video information corresponding to the selected human face picture in the established human face classification database at the side of the cloud server, and sends the video information corresponding to the selected human face picture to the video player. Accordingly, the video player receives the video information sent by the cloud server.

On the basis of the technical solution of the foregoing embodiment, optionally, the method, after the step 102 of “displaying the video information corresponding to the selected human face picture”, may further specifically include: merging at least one video segment as a locating video corresponding to the selected human face picture according to the information of the at least one video segment of the selected human face picture.

For example, various corresponding video segments are specifically acquired from the video according to the starting time and the ending time of various video segments according to the information of the at least one video, and the video segments are merged together to form the locating video corresponding to the selected human face picture.

Various optional solutions of the foregoing embodiment may be combined freely using a combinative manner to form the optional embodiment of the present disclosure, which will not be elaborated one by one herein.

The video processing method of the foregoing embodiment implements to locate the video of the selected human face picture through establishing the human face classification database and after receiving the video locating request carrying the selected human face picture sent by the user, has a very high video locating efficiency. Moreover, employing the technical solution of the foregoing embodiment facilitates the user to view all the performances of the actor in the video corresponding to the selected human face picture, and the user experience degree is very good.

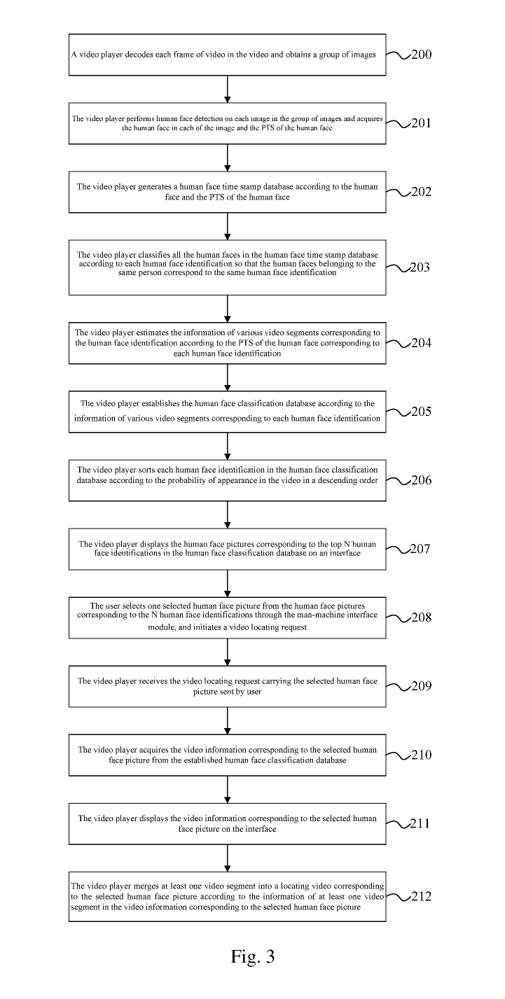

FIG. 3 is a flow chart of another embodiment of the video processing method according to the embodiment of the present disclosure. As shown in FIG. 3, the video processing method of the embodiment, on the basis of the technical solution of the foregoing embodiment, describes an application scene of the present disclosure. As shown in FIG. 3, the video processing method of the embodiment may specifically include the following steps.

In step 200, the video player decodes each frame of video in the video and obtains a group of images.

The application scene of the embodiment is that the technical solution of the present disclosure is described by taking an example that when the user uses a video locating processing function at one side of the video player through the man-machine interface module, and no communication connection exists between the video player and the cloud server, then both the establishing human face classification database and performing the video locating request according to the human face classification database are preformed at the side of the video player, i.e., the side of the client of the video playing system for performing video processing.

In step 201, the video player performs human face detection on each image in the group of images, and acquires the human face in each image and the PTS of the human face.

In step 202, the video player generates a human face time stamp database according to the human face and the PTS of the human face.

In step 203, the video player classifies all the human faces in the human face time stamp database according to each human face identification so that the human faces belonging to the same person correspond to the same human face identification.

In step 204, the video player estimates the information of various video segments corresponding to the human face identification according to the PTS of the human face corresponding to each human face identification.

For example, the video segment information includes the starting time and the ending time of the video segment.

In step 205, the video player establishes the human face classification database according to the information of various video segments corresponding to each human face identification.

Wherein, the human face classification database may include the human face identification and the information of various video segments in the video corresponding to the human face identification.

In step 206, the video player sorts each human face identification in the human face classification database according to the probability of appearance in the video in a descending order.

In step 207, the video player displays the human face pictures corresponding to the top N human face identifications in the human face classification database on an interface.

Wherein, N is an integer more than or equal to 1; displaying the top N human face identifications in the human face classification database in the embodiment is to tell the user that the N human faces in the video are the important actors having a higher probability of appearance, and the user may know the various leading actors and supporting actors in the video.

In step 208, the user selects one selected human face picture from the human face pictures corresponding to the N human face identifications through the man-machine interface module, and initiates a video locating request.

In the embodiment, it is illustrated by taking one human face picture selected from the human face pictures corresponding to the top N human face identifications in the human face classification database displayed on the interface of the video player as the selected human face picture for example. In practical application, the selected human face picture may also be acquired through a manner of photographing or downloading from the network, which will not be illustrated one by one.

In step 209, the video player receives the video locating request carrying the selected human face picture sent by user.

In step 210, the video player acquires the video information corresponding to the selected human face picture from the established human face classification database.

The video information includes the identification of the selected human face picture and the information of at least one video segment of the selected human face picture. The video information corresponding to the selected human face picture established in the human face classification database may also include each of the selected human face picture.

To be specific, the video player may perform human face identification on the selected human face picture with each of the human face picture in the human face classification database, for example, the human face identification may be performed through a characteristic value matching algorithm, so that the video information corresponding to the selected human face picture is acquired from the human face classification database.

In step 211, the video player displays the video information corresponding to the selected human face picture on the interface.

The user may click to view various video segments corresponding to the video information according to the starting time and the ending time of the selected human face picture displayed on the interface of the video player, view all the corresponding video segments of the selected human face picture in the video, and know the acting skills of the actor corresponding to the selected human face picture in the video.

In step 212, the video player merges at least one video segment into a locating video corresponding to the selected human face picture according to the information of at least one video segment in the video information corresponding to the selected human face picture.

Please refer to the records of related embodiments above for the details of the implementation of each step in the embodiment, and the details will not be elaborated herein.

The video processing method of the embodiment implements to implements to locate the video of the selected human face picture through establishing the human face classification database at the side of the video player and after receiving the video locating request carrying the selected human face picture sent by the user, has a very high video locating efficiency. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, so that the user experience degree is also very good.

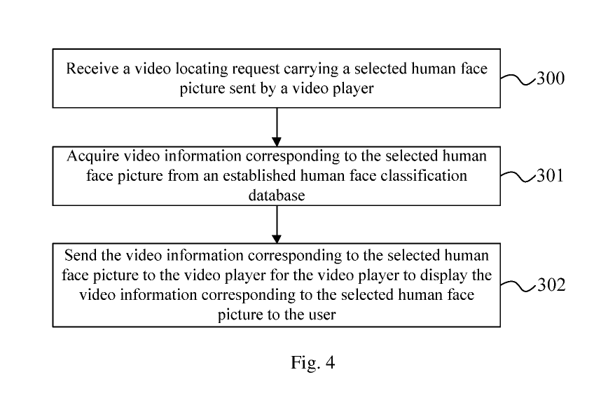

FIG. 4 is a flow chart of further embodiment of the video processing method according to the embodiment of the present disclosure. As shown in FIG. 3, the video processing method of the embodiment may particularly include the following steps.

In step 300, a video locating request carrying a selected human face picture sent by a video player is received.

The video locating request in the embodiment is sent by a user through a man-machine interface module and received by the video player. The video processing method of the embodiment describes the technical solution of the present disclosure at the side of a cloud server.

In step 301, video information corresponding to the selected human face picture is acquired from an established human face classification database.

Wherein, the video information in the embodiment includes the identification of the selected human face picture and the information of at least one video segment of the selected human face picture; and for example, the video information may also include the selected human face picture. Please refer to the records of the foregoing embodiment for the details, and the details will not be elaborated herein.

In step 302, the video information corresponding to the selected human face picture is sent to the video player for the video player to display the video information corresponding to the selected human face picture to the user.

Finally, the cloud server after acquiring the video information corresponding to the selected human face picture, sends the video information corresponding to the selected human face picture to the video player, and the video player may display the video information corresponding to the selected human face picture to the user on an interface; the user may view all the corresponding video segments of the selected human face picture in the video according to the video information of the selected human face picture displayed, and may further determine the acting skills of the actor corresponding to the selected human face picture in the video according to these video segments.

The embodiment differs from the foregoing embodiment as shown in FIG. 1 in that the foregoing embodiment as shown in FIG. 1 describes the video processing solution of the present disclosure by implementing all the video processing solutions at the side of the video player in a case that no communication connection between the video player (i.e., client) and the cloud server.

While communication connection exists between the cloud server and the video player in the embodiment; after receiving the video locating request sent by the user through the man-machine interface module, the video player may acquire the video information corresponding to the selected human face picture from the established human face classification database. Finally, the video information corresponding to the selected human face picture is sent to the video player for the video player to display the video information corresponding to the selected human face picture to the user. That is, the technical solution of the present disclosure is described specifically by taking the communication connection existing between the video player and the cloud server for example, wherein the implementing principles of various steps thereof are similar. Please refer to the records of the foregoing embodiments as shown in FIG. 1 for the details, and the details will not be elaborated herein.

The video processing method of the embodiment implements to locate the video of the selected human face picture according to the human face classification database through receiving the video locating request carrying the selected human face picture sent by the video player, acquiring the video information corresponding to the selected human face picture from the established human face classification database, and sending the video information corresponding to the selected human face picture to the video player for the video player to display the video information corresponding to the selected human face picture to the user, has a very high video locating efficiency. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, so that the user experience degree is also very good.

Further optionally, on the basis of the technical solution of the foregoing embodiment, the method, before the step 301 of “acquiring the video information corresponding to the selected human face picture from the established human face classification database”, may also include: establishing the human face classification database. That is, the human face classification database is established at the side of the cloud server in the embodiment, wherein the structure of the human face classification database and the information included are the same as that of the human face classification database established at the side of the video player in the foregoing embodiment. Please refer to the records of the foregoing embodiment for details, and the details will not be elaborated herein.

Further optionally, the “establishing the human face classification database” in the foregoing embodiment may specifically include the following steps.

(a) Each frame video in the video is decoded and a group of images are obtained;

(b) Human face detection is performed on each image in the group of images, and the human face in each image and the PTS of the human face are acquired.

(c) A human face time stamp database is generated according to the human face and the PTS of the human face.

(d) All the human faces in the human face time stamp database are classified according to each human face identification so that the human faces belonging to the same person correspond to the same human face identification.

(e) The information of various video segments corresponding to the human face identification is estimated according to the PTS of the human face corresponding to each human face identification. The video segment information includes the starting and ending time of the video segment.

(f) The human face classification database is established according to the information of various video segments corresponding to each human face identification.

The implementation of the foregoing steps (a) to (f) of the embodiment are the same as the implementation of the steps (1) to (6) in the subsequent optional technical solution of the foregoing embodiment as shown in FIG. 1. Please refer to the records of the foregoing embodiment for details, and the details will not be elaborated herein.

Further optionally, the method, after the step (f) of “establishing the human face classification database according to the information of various video segments corresponding to each human face identification” in the foregoing embodiment, may further include: sorting each human face identification in the human face classification database according to the probability of appearance in the video in a descending order.

Or further optionally, the method, after the step of “sorting each human face identification in the human face classification database according to the probability of appearance in the video in a descending order”, and before the step 300 of “receiving the video locating request carrying the selected human face picture sent by the video player”, may also include: sending the top N human face identifications of the human face classification database to the video player for the video player to display the human face pictures corresponding to the top N human face identifications to the user, N being an integer more than or equal to 1;

at this moment, the corresponding selected human face picture being selected by the user from the human face pictures corresponding to the N human face identities; or the selected human face picture also being inputted by the user through the man-machine interface module.

Or further optionally, the established human face classification database at the side of the cloud server may be established at the side of the video player, and is sent to be cloud server after communication connection exists between the side of the cloud server and the side of the video player. For example, the method, before the step 301 of “acquiring the video information corresponding to the selected human face picture from the established human face classification database” in the foregoing embodiment, may further include: receiving the human face classification database sent by the video player.

All of the various optional solutions in the foregoing embodiments describe the technical solution of the present disclosure at the side of the cloud server. Please refer to the implementation at the side of the video player for the detailed implementation manner, and the detailed implementation manner will not be elaborated herein. Various optional solutions of the foregoing embodiment may be combined freely using a combinative manner to form the optional embodiment of the present disclosure, which will not be elaborated one by one herein.

The video processing method of the foregoing embodiment implements to locate the video of the selected human face picture according to the human face classification database through establishing the human face classification database at the side of the cloud server and after receiving the video locating request carrying the selected human face picture sent by the video player, and returns the structured located to the video player for the video player to display the structured located to the user, has a very high video locating efficiency. Moreover, employing the technical solution of the foregoing embodiment facilitates the user to view all the performances of the actor in the video corresponding to the selected human face picture, and the user experience degree is very good.

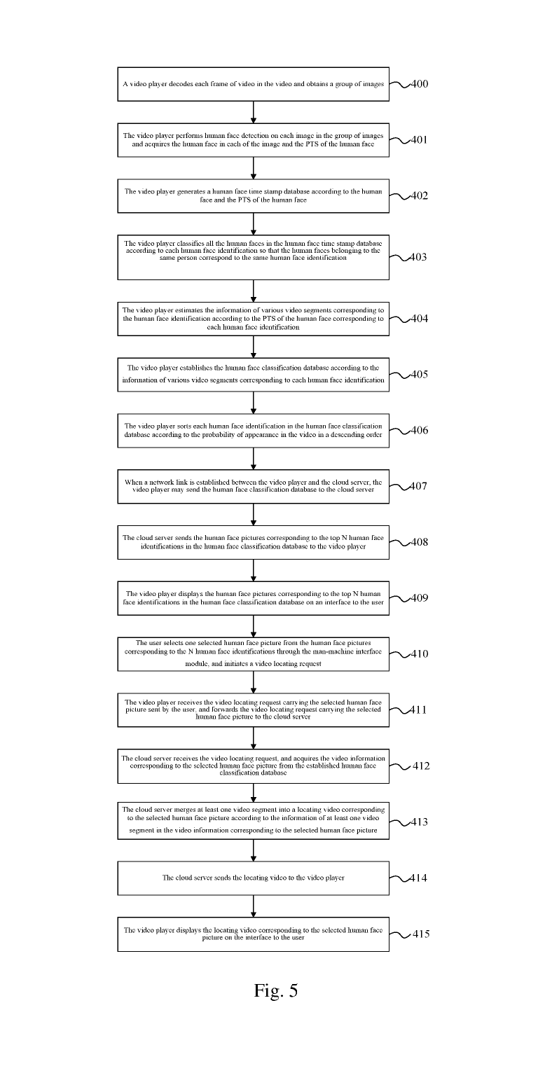

FIG. 5 is a flow chart of still another embodiment of the video processing method according to the embodiment of the present disclosure. As shown in FIG. 5, the video processing method of the embodiment describes yet another application scene of the present disclosure. As shown in FIG. 5, the video processing method of the embodiment may specifically include the following steps.

In step 400, a video player decodes each frame of video in the video and obtains a group of images.

The application scene of the embodiment is that the technical solution of the present disclosure is described by taking an example that when a user uses a video locating processing function at one side of the video player through a man-machine interface module, no communication connection exists between the video player and a cloud server, and the establishing of a human face classification database is performed at the side of the video player, i.e., a client of a video playing system; however, the communication connection between the video player and the cloud server is restored subsequently, then the video player sends the human face classification database established to the cloud server again, and then the cloud server performs a video locating request for video processing subsequently according to the human face classification database.

In step 401, the video player performs human face detection on each image in the group of images, and acquires the human face in each image and the PTS of the human face.

In step 402, the video player generates a human face time stamp database according to the human face and the PTS of the human face.

In step 403, the video player classifies all the human faces in the human face time stamp database according to each human face identification so that the human faces belonging to the same person correspond to the same human face identification.

In step 404, the video player estimates the information of various video segments corresponding to the human face identification according to the PTS of the human face corresponding to each human face identification.

For example, the video segment information includes the starting time and the ending time of the video segment.

In step 405, the video player establishes the human face classification database according to the information of various video segments corresponding to each human face identification.

Wherein, the human face classification database may include the human face identification and the information of various video segments in the video corresponding to the human face identification.

In step 406, the video player sorts each human face identification in the human face classification database according to the probability of appearance in the video in a descending order.

In step 407, when a network link is established between the video player and the cloud server, the video player may send the human face classification database to the cloud server.

In this way, video processing may be performed at the side of the cloud server subsequently, so that the resource losses of the client of the video player are reduced, and the video processing efficiency is improved.

In step 408, the cloud server sends the human face pictures corresponding to the top N human face identifications in the human face classification database to the video player, wherein, N is an integer more than or equal to 1.

In step 409, the video player displays the human face pictures corresponding to the top N human face identifications in the human face classification database on an interface to the user.

In this way, the user may determine the leading and supporting actors in the video according to the human faces displayed. And further, one human face may be selected therefrom as a selected human face picture and a video locating request may be initiated so as to request for viewing all the video segments of the selected human face picture in the video.

In step 410, the user selects one selected human face picture from the human face pictures corresponding to the N human face identifications through the man-machine interface module, and initiates a video locating request.

In step 411, the video player receives the video locating request carrying the selected human face picture sent by the user, and forwards the video locating request carrying the selected human face picture to the cloud server.

In step 412, the cloud server receives the video locating request, and acquires the video information corresponding to the selected human face picture from the established human face classification database.

The video information includes the identification of the selected human face picture and the information of at least one video segment of the selected human face picture. The video information corresponding to the selected human face picture established in the human face classification database may also include each of the selected human face picture.

To be specific, the cloud server may perform human face identification on the selected human face picture with each of the human face picture in the human face classification database, for example, the human face identification may be performed through a characteristic value matching algorithm, so that the video information corresponding to the selected human face picture is acquired from the human face classification database.

At this moment, the cloud server may send the video information corresponding to the selected human face picture to the video player, and the video player displays the video information corresponding to the selected human face picture on the interface.

The user may click to view various video segments corresponding to the video information according to the starting time and the ending time of the selected human face picture displayed on the interface of the video player, view all the corresponding video segments of the selected human face picture in the video, and know the acting skills of the actor corresponding to the selected human face picture in the video.

Or further, the method may further include the following steps.

In step 413, the cloud server merges at least one video segment into a locating video corresponding to the selected human face picture according to the information of at least one video segment in the video information corresponding to the selected human face picture.

Or in the embodiment, the cloud server may also directly send the video information corresponding to the selected human face picture to a video playing server, and the video player merges the at least one video segment into the locating video corresponding to the selected human face picture according to the information of the at least one video segment in the video information corresponding to the selected human face picture.

In step 414, the cloud server sends the locating video to the video player.

In step 415, the video player displays the locating video corresponding to the selected human face picture on the interface to the user.

In the embodiment, the locating video is a set of all the video segments of the selected human face picture in the video; when the video player displays the locating video corresponding to the selected human face picture on the interface to the user, the user may view all the video segments in the video corresponding to the selected human face picture, and know the acting skills of an actor corresponding to the selected human face picture in the video.

Please refer to the records of related embodiments above for the details of the implementation of each step in the embodiment, and the details will not be elaborated herein.

The video processing method of the embodiment establishes the human face classification database at the side of the video player; moreover, when the cloud server and the video player are in communication connection, the human face classification database is sent to the cloud server by the video player, while the processing of the subsequent video locating request is performed at the side of the cloud server, i.e., the video of the selected human face picture is located according to the human face classification database after the cloud server receives the video locating request carrying the selected human face picture sent by the video player, has a very high video locating efficiency. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, so that the user experience degree is also very good.

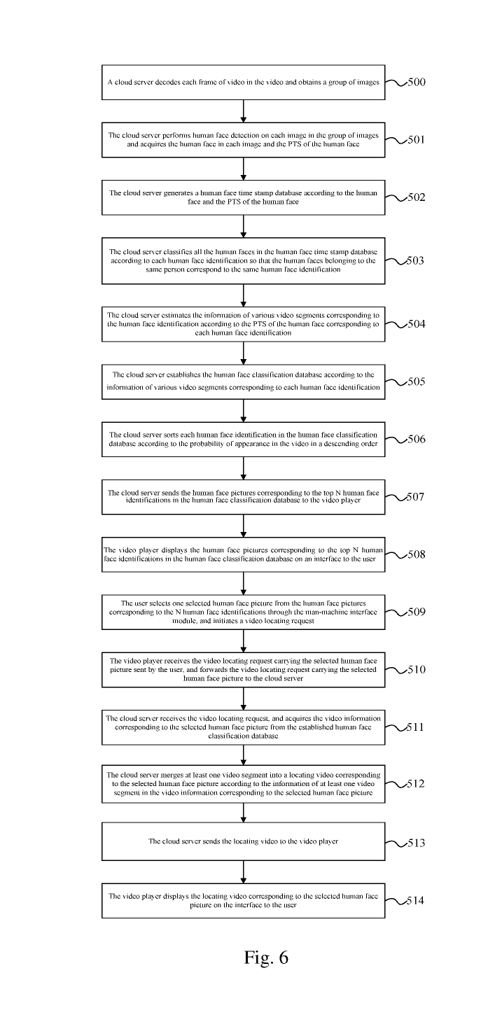

FIG. 6 is a flow chart of yet another embodiment of the video processing method according to the embodiment of the present disclosure. As shown in FIG. 6, the video processing method of the embodiment, on the basis of the technical solution of the foregoing embodiment, describes yet another application scene of the present disclosure. As shown in FIG. 6, the video processing method of the embodiment may specifically include the following steps.

In step 500, the cloud server decodes each frame of video in the video and obtains a group of images.

The application scene of the embodiment is that the technical solution of the present disclosure is described by taking an example that when the user uses a video locating processing function at one side of the video player through the man-machine interface module, and communication connection exists between the video player and the cloud server, the establishing of the human face classification database is performed at the side of the cloud server, and then the video locating request is performed by the cloud server subsequently according to the human face classification database for performing video processing.

In step 501, the cloud server performs human face detection on each image in the group of images, and acquires the human face in each image and the PTS of the human face.

In step 502, the cloud server generates a human face time stamp database according to the human face and the PTS of the human face.

In step 503, the cloud server classifies all the human faces in the human face time stamp database according to each human face identification so that the human faces belonging to the same person correspond to the same human face identification.

In step 504, the cloud server estimates the information of various video segments corresponding to the human face identification according to the PTS of the human face corresponding to each human face identification.

For example, the video segment information includes the starting time and the ending time of the video segment.

In step 505, the cloud server establishes the human face classification database according to the information of various video segments corresponding to each human face identification.

Wherein, the human face classification database may include the human face identification and the information of various video segments in the video corresponding to the human face identification.

In step 506, the cloud server sorts each human face identification in the human face classification database according to the probability of appearance in the video in a descending order.

In this way, video processing may be performed at the side of the cloud server subsequently, so that the resource losses of the client of the video player are reduced, and the video processing efficiency is improved.

In step 507, the cloud server sends the human face pictures corresponding to the top N human face identifications in the human face classification database to the video player, wherein, N is an integer more than or equal to 1.

In step 508, the video player displays the human face pictures corresponding to the top N human face identifications in the human face classification database on an interface to the user.

In this way, the user may determine the leading and supporting actors in the video according to the human faces displayed. And further, one human face may be selected therefrom as a selected human face picture and a video locating request may be initiated so as to request for viewing all the video segments of the selected human face picture in the video.

In step 509, the user selects one selected human face picture from the human face pictures corresponding to the N human face identifications through the man-machine interface module, and initiates a video locating request.

Or, the user may also independently input the selected human face picture through the man-machine interface module using a manner of photographing or downloading images, and initiate the video locating request.

In step 510, the video player receives the video locating request carrying the selected human face picture sent by the user, and forwards the video locating request carrying the selected human face picture to the cloud server.

In step 511, the cloud server receives the video locating request, and acquires the video information corresponding to the selected human face picture from the established human face classification database.

The video information includes the identification of the selected human face picture and the information of at least one video segment of the selected human face picture. The video information corresponding to the selected human face picture established in the human face classification database may also include each of the selected human face picture.

At this moment, the cloud server may send the video information corresponding to the selected human face picture to the video player, and the video player displays the video information corresponding to the selected human face picture on the interface.

The user may click to view various video segments corresponding to the video information according to the starting time and the ending time of the selected human face picture displayed on the interface of the video player, view all the corresponding video segments of the selected human face picture in the video, and know the acting skills of the actor corresponding to the selected human face picture in the video.

Or further, the method may further include the following steps.

In step 512, the cloud server merges at least one video segment into a locating video corresponding to the selected human face picture according to the information of at least one video segment in the video information corresponding to the selected human face picture.

In step 513, the cloud server sends the locating video to the video player.

In step 514, the video player displays the locating video corresponding to the selected human face picture on the interface to the user.

In the embodiment, the locating video is a set of all the video segments of the selected human face picture in the video; when the video player displays the locating video corresponding to the selected human face picture on the interface to the user, the user may view all the video segments in the video corresponding to the selected human face picture, and know the acting skills of an actor corresponding to the selected human face picture in the video.

Please refer to the records of related embodiments above for the details of the implementation of each step in the embodiment, and the details will not be elaborated herein.

The video processing method of the embodiment implements to locate the video of the selected human face picture according to the human face classification database through establishing the human face classification database at the side of the cloud server and performing the subsequent video locating request at the side of the cloud server, i.e., after the cloud server receives the video locating request carrying the selected human face picture sent by the user, and has a very high video locating efficiency. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

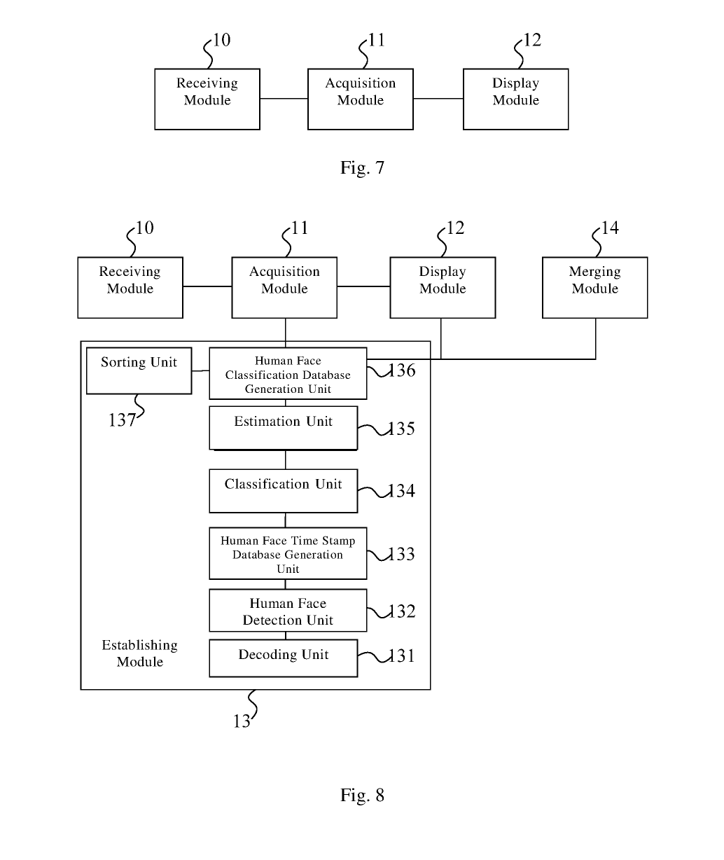

FIG. 7 is a structure diagram of one embodiment of a video player according to the embodiment of the present disclosure. As shown in FIG. 7, the video player of the embodiment may particularly include: a receiving module 10, an acquisition module 11 and a display module 12.

Wherein, the receiving module 40 is configured to receive a video locating request carrying a selected human face picture sent by a user through a man-machine interface module; the acquisition module 11 is connected with the receiving module 10, and the acquisition module 11 is configured to acquire video information in a video corresponding to the selected human face picture in the video locating request received by the receiving module 10, the video information including the identification of the selected human face picture and the information of at least one video segment of the selected human face picture; and the display module 12 is connected with the acquisition module 11, and the display module 12 is configured to display the video information corresponding to the selected human face picture acquired by the acquisition module 11.

The implementing mechanism of the video player of the embodiment for implementing video processing using the foregoing modules is the same as the implementing mechanism of the method embodiment as shown in FIG. 1. Please refer to the records of the embodiment as shown in FIG. 1 for details, and the details which will not be elaborated herein.

By employing the foregoing modules, the video player of the embodiment implements to receive the video locating request carrying the selected human face picture sent by the user, acquire the video information in the video corresponding to the selected human face picture in the video locating request, and display the video information corresponding to the selected human face picture. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

FIG. 8 is a structure diagram of another embodiment of the video player according to the embodiment of the present disclosure. As shown in FIG. 8, the video player of the embodiment is on the basis of the technical solution of the foregoing embodiment as shown in FIG. 7, which further describes the technical solution of the present disclosure in details.

Further optionally, the acquisition module 11 in the video player of the embodiment is specifically configured to acquire the video information corresponding to the selected human face picture from an established human face classification database.

As shown in FIG. 8, and further optionally, the video player of the embodiment further includes: an establishing module 13 configured to establish the human face classification database. At this moment, the acquisition module 11 is connected with the establishing module 13 accordingly, and the acquisition module 11 is specifically configured to acquire the video information corresponding to the selected human face picture from the human face classification database established by the establishing module 13.

As shown in FIG. 8, further optionally, the establishing module 13 in the video player of the embodiment specifically includes: a decoding unit 131, a human face detection unit 132, a human face time stamp database generation unit 133, a classification unit 134, an estimation unit 135 and a human face classification database generation unit 136.

Wherein, the decoding unit 131 is configured to decode each frame of video in the video and obtain a group of images; the human face detection unit 132 is connected with the decoding unit 131, and the human face detection unit 132 is configured to perform human face detection on each image in the group of images obtained by the decoding unit 131, and acquire the human face in each image and the PTS of the human face; the human face time stamp database generation unit 133 is connected with the human face detection unit 132, and the human face time stamp database generation unit 133 is configured to generate a human face time stamp database according to the human face and the PTS of the human face obtained by detection of the human face detection unit 132; the classification unit 134 is connected with the human face time stamp database generation unit 133, and the classification unit 134 is configured to classify all the human faces in the human face time stamp database generated by the human face time stamp database generation unit 133 according to each human face identification, so that the human faces belonging to the same person correspond to the same human face identification; the estimation unit 135 is connected with the classification unit 134, and the estimation unit 135 is configured to estimate various segments of the video segment information of the human face corresponding to the human face identification according to the PTS of the human face corresponding to each human face identification after being classified by the classification unit 134, the video segment information including the starting and ending time of the video segment; the human face classification database generation unit 136 is connected with the estimation unit 135, and the human face classification database generation unit 136 is configured to establish the human face classification database according to the various segments of the video segment information corresponding to each human face identification obtained by the estimation unit 135.

Further optionally, as shown in FIG. 8, the establishing module 13 in the video player of the embodiment further includes: a sorting unit 137, wherein the sorting unit 137 is connected with the human face classification database generation unit 136, and the sorting unit 137 is configured to sort each human face identification in the human face classification database generated by the human face classification database generation unit 136 according to the probability of appearance in the video in a descending order.

At this moment, the acquisition module 11 is connected with the human face classification database generation unit 136 accordingly, and the acquisition module 11 is specifically configured to acquire the video information corresponding to the selected human face picture from the human face classification database established by the human face classification database generation unit 136.

Further optionally, the display module 12 in the video player of the embodiment is also connected with the human face classification database generation unit 136, and the display module 12 is configured to display the human face pictures corresponding to the top N human face identifications in the human face classification database after being sorted, the N being an integer more than or equal to 1; and further, the selected human face picture being selected by the user from the human face pictures corresponding to the N human face identifications; or the selected human face picture being inputted by the user through the man-machine interface module.

Further optionally, the video player of the embodiment further includes: a merging module 14. The merging module 14 is connected with the human face classification database generation unit 136, and the merging module 14 is configured to merge at least one video segment as a locating video corresponding to the selected human face picture according to the information of at least one video segment of the selected human face picture in the human face classification database generated by the human face classification database generation unit 136.

According to the foregoing technical solution of the video player of the embodiment, the human face classification database is established at the side of the video player, and video processing is performed according to the video locating request carrying the selected human face picture sent by the user.

The implementing mechanism of the video player of the embodiment for implementing video processing using the foregoing modules is the same as the implementing mechanism of the method embodiment as shown in FIG. 3. Please refer to the records of the embodiment as shown in FIG. 1 for details which will not be elaborated herein.

By employing the foregoing modules, the video player of the embodiment implements to establish the human face classification database, and implement to locate the video of the selected human face picture according to the human face classification database after receiving the video locating request carrying the selected human face picture sent by the user, and has a very high video locating efficiency. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

FIG. 9 is a structure diagram of further embodiment of the video player according to the embodiment of the present disclosure. As shown in FIG. 9, the video player of the embodiment is on the basis of the technical solution of the foregoing embodiment as shown in FIG. 8, which further describes the technical solution of the present disclosure in details.

Further optionally, as shown in FIG. 9, the video player of the embodiment further includes a sending module 15. The sending module 15 is connected with the human face classification database generation unit 136, and is configured to send the human face classification database generated by the human face classification database generation unit 136 to a cloud server.

Further optionally, the sending module 15 in the video player of the embodiment is also connected with the receiving module 10, and the sending module 15 is further specifically configured to send the video locating request carrying the selected human face picture received by the receiving module 10 to the cloud server; and the receiving module 10 is further specifically configured to receive the video information sent by the cloud server, the video information being acquired by the cloud server from the human face classification database established in the cloud server according to the selected human face picture.

At this moment, and further optionally, the merging module 14 is connected with the receiving module 10 accordingly, and the merging module 14 is configured to merge at least one video segment as a locating video corresponding to the selected human face picture according to the information of at least one video segment of the selected human face picture in the video information received by the receiving module 10.

According to the video player of the embodiment, the human face classification database is established at the side of the video player, and the human face classification database is sent to the cloud server; and after the video player receives the video locating request carrying the selected human face picture, the video player sends the video locating request to the cloud server, and the cloud server performs video processing according to the video locating request carrying the selected human face picture.

The implementing mechanism of the video player of the embodiment for implementing video processing using the foregoing modules is the same as the implementing mechanism of the method embodiment as shown in FIG. 5. Please refer to the records of the embodiment as shown in FIG. 5 for details which will not be elaborated herein.

By employing the foregoing modules, the video player of the embodiment implements to establish the human face classification database at the side of the video player; moreover, when the cloud server and the video player are in communication connection, the human face classification database is sent to the cloud server by the video player, while the processing of the subsequent video locating request is performed at the side of the cloud server, i.e., the video of the selected human face picture is located according to the human face classification database after the cloud server receives the video locating request carrying the selected human face picture sent by the video player, has a very high video locating efficiency. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

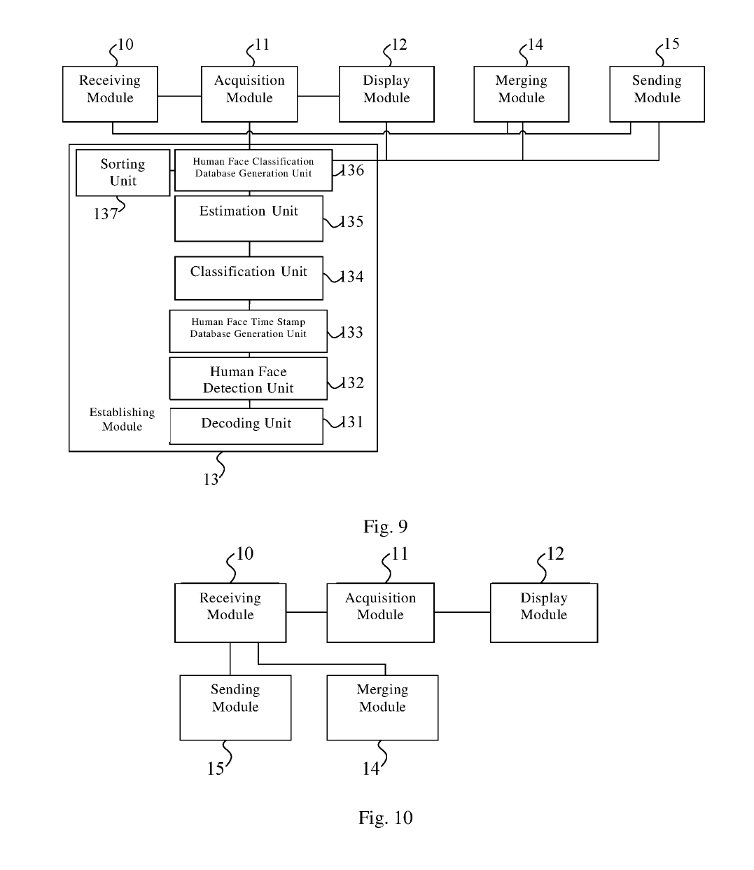

FIG. 10 is a structure diagram of still another embodiment of the video player according to the embodiment of the present disclosure. As shown in FIG. 10, the video player of the embodiment on the basis of the technical solution of the embodiment as shown in FIG. 7, further includes the following technical solution.

The video player of the embodiment also includes a sending module 15. The sending module 15 is connected with the receiving module 10, and the sending module 15 is further specifically configured to send the video locating request carrying the selected human face picture to the cloud server received by the receiving module 10; and the receiving module 10 is further specifically configured to receive the video information sent by the cloud server, the video information being acquired by the cloud server from the human face classification database established in the cloud server according to the selected human face picture.

At this moment, the merging module 14 is connected with the acquisition module 11 accordingly, and the merging module 14 is configured to merge at least one video segment as a locating video corresponding to the selected human face picture according to the information of at least one video segment of the selected human face picture in the video information acquired by the acquisition module 11. Optionally, the merging module 14 may also be disposed at the side of the cloud server. At this moment, the corresponding acquisition module 11 may also be configured to directly receive the locating video corresponding to the selected human face picture sent by a video server.

Compared with the foregoing embodiment as shown in FIG. 9, an establishing module 13 is omitted in the video player of the embodiment. According to the video player of the embodiment, the human face classification database is established at the side of the cloud server; moreover, the video player sends the video locating request to the cloud server after the video player receives the video locating request carrying the selected human face picture, and the cloud server performs video processing according to the video locating request carrying the selected human face picture. Please refer to the records of related method embodiments above for the details of the implementing mechanism of the video player of the embodiment for implementing video processing using the foregoing modules as well, and the details will not be elaborated herein.

After the video player of the embodiment implements to receive the video locating request carrying the selected human face picture by using the foregoing modules, the video player sends the video locating request to the cloud server, and the cloud server performs video processing according to the video locating request carrying the selected human face picture, has a very high video locating efficiency. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

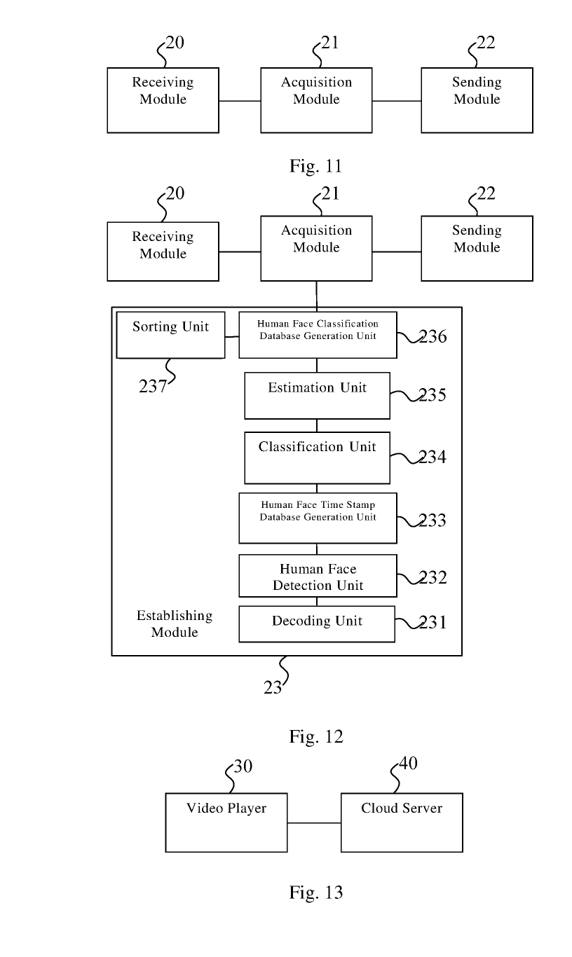

FIG. 11 is a structure diagram of one embodiment of a cloud server according to the embodiment of the present disclosure. As shown in FIG. 11, the cloud server of the embodiment may include: a receiving module 20, an acquisition module 21 and a sending module 22. Wherein, the receiving module 20 is configured to receive a video locating request carrying a selected human face picture sent by a video player, the video locating request being sent by a user through a man-machine interface module and received by the video player; the acquisition module 21 is connected with the receiving module 20, and the acquisition module 21 is configured to acquire the video information corresponding to the selected human face picture received by the receiving module 20 from an established human face classification database, the video information including the identification of the selected human face picture and the information of at least one video segment of the selected human face picture; and the sending module 22 is connected with the acquisition module 21, and the sending module 22 is configured to send the video information corresponding to the selected human face picture acquired by the acquisition module 21 to the video player for the video player to display the video information corresponding to the selected human face picture to the user.

The implementing mechanism of the cloud server of the embodiment for implementing video processing using the foregoing modules is the same as the implementing mechanism of the method embodiment as shown in FIG. 4. Please refer to the records of the embodiment as shown in FIG. 4 for details which will not be elaborated herein.

By employing the foregoing modules, the cloud server of the embodiment implements to receive the video locating request carrying the selected human face picture sent by the video player, acquire the video information corresponding to the selected human face picture from the established human face classification database, and send the video information corresponding to the selected human face picture to the video player for the video player to display the video information corresponding to the selected human face picture to the user and implement to locate the video of the selected human face picture according to the human face classification database, has a very high video locating efficiency. The video processing method of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

FIG. 12 is a structure diagram of another embodiment of the cloud server according to the embodiment of the present disclosure. As shown in FIG. 12, the cloud server of the embodiment is on the basis of the technical solution of the foregoing embodiment as shown in FIG. 11, which further describes the technical solution of the present disclosure in details.

As shown in FIG. 12, the cloud server of the embodiment further includes: an establishing module 23, wherein the establishing module 23 is configured to establish the human face classification database. At this moment, the acquisition module 21 is also connected with the establishing module 23 accordingly, and the acquisition module 21 is specifically configured to acquire the video information corresponding to the selected human face picture received by the receiving module 20 from the human face classification database established by the establishing module 23.

As shown in FIG. 12, further optionally, the establishing module 23 in the cloud server of the embodiment specifically includes: a decoding unit 231, a human face detection unit 232, a human face time stamp database generation unit 233, a classification unit 234, an estimation unit 235 and a human face classification database generation unit 236.

Wherein, the decoding unit 231 is configured to decode each frame of video in the video and obtain a group of images; the human face detection unit 232 is connected with the decoding unit 231, and the human face detection unit 232 is configured to perform human face detection on each image in the group of images obtained by the decoding unit 231, and acquire the human face in each image and the PTS of the human face; the human face time stamp database generation unit 233 is connected with the human face detection unit 232, and the human face time stamp database generation unit 233 is configured to generate a human face time stamp database according to the human face and the PTS of the human face obtained by detection of the human face detection unit 232; the classification unit 234 is connected with the human face time stamp database generation unit 233, and the classification unit 234 is configured to classify all the human faces in the human face time stamp database generated by the human face time stamp database generation unit 233 according to each human face identification, so that the human faces belonging to the same person correspond to the same human face identification; the estimation unit 235 is connected with the classification unit 234, and the estimation unit 235 is configured to estimate various segments of the video segment information of the human face corresponding to the human face identification according to the PTS of the human face corresponding to each human face identification after being classified by the classification unit 234, the video segment information including the starting and ending time of the video segment; the human face classification database generation unit 236 is connected with the estimation unit 235, and the human face classification database generation unit 236 is configured to establish the human face classification database according to the various types of the video segment information corresponding to each human face identification obtained by the estimation unit 235.

Further optionally, and as shown in FIG. 12, the establishing module 23 in the cloud server of the embodiment further includes a sorting unit 237, wherein the sorting unit 237 is connected with the human face classification database generation unit 236, and the sorting unit 237 is configured to sort each human face identification in the human face classification database generated by the human face classification database generation unit 236 according to the probability of appearance in the video in a descending order.

At this moment, the acquisition module 21 is also connected with the human face classification database generation unit 236 accordingly, and the acquisition module 21 is specifically configured to acquire the video information corresponding to the selected human face picture received by the receiving module 20 from the human face classification database generation unit 236.

Further optionally, the sending module 22 in the cloud server of the embodiment is further configured to send the top N human face identifications in the human face classification database to the video player for the video player to display the top N human face identifications to the user, the N being an integer more than or equal to 1; and accordingly, the selected human face picture in the video locating request received by the receiving module 20 being selected by the user from the human face pictures corresponding to the N human face identifications; or the selected human face picture being inputted by the user through the man-machine interface module.

According to the cloud server of the embodiment, the human face classification database is established at the side of the cloud server; moreover, the cloud server performs video processing according to the video locating request carrying the selected human face picture after receiving the video locating request carrying the selected human face picture sent by the video player.

The implementing mechanism of the cloud server of the embodiment for implementing video processing using the foregoing modules is the same as the implementing mechanism of the method embodiment as shown in FIG. 6. Please refer to the records of the embodiment as shown in FIG. 6 for details which will not be elaborated herein.

Or optionally, when the human face classification database is established at the side of the video player and sent to the cloud server by the video player, and the cloud server performs video processing according to the video locating request carrying the selected human face picture, the receiving module 20 in the cloud server of the embodiment at this moment is further configured to receive the human face classification database sent by the video player.

By employing the foregoing modules, the cloud server of the embodiment implements to establish the human face classification database at the side of the video player, while the processing of the subsequent video locating request is performed at the side of the cloud server, i.e., the video of the selected human face picture is located according to the human face classification database after the cloud server receives the video locating request carrying the selected human face picture sent by the video player, has a very high video locating efficiency. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

FIG. 13 is a structure diagram of an embodiment of a video playing system according to the embodiment of the present disclosure. As shown in FIG. 13, the video playing system of the embodiment includes a video player 30 and a cloud server 40, wherein the video player 30 and the cloud server 40 are in communication connection. For example, the video player of the embodiment as shown in FIG. 9 above is employed as the video player 30 of the embodiment, and accordingly, the cloud server as shown in FIG. 11 above is employed as the cloud server 40, and the video processing method according to the embodiment as shown in FIG. 5 above may be specifically employed for implementing video processing. Or, the video player according to the embodiment as shown in FIG. 10 above is employed as the video player 30 of the embodiment, and accordingly, the cloud server as shown in FIG. 12 above is employed as the cloud server 40, and the video processing method according to the embodiment as shown in FIG. 6 above may be specifically employed for implementing video processing. Please refer to the records of related embodiments above for the details which will not be elaborated herein.

By employing the video player 30 and the cloud server 40 above, the video playing system of the embodiment may implement to locate the video of the selected human face picture according to the human face classification database, has a very high video locating efficiency. The technical solution of the embodiment may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the video processing method of the embodiment facilitates users to view the all the performances of an actor corresponding to the selected human face picture in the video, and the user experience degree is also very good.

It may be understood by those having ordinary skills in the art that the all or a part of steps of implementing the various embodiments of the method above may be finished through relevant hardware instructed by a program. The program may be stored in a mobile device or a computer readable storage medium, and the program while performing includes the steps of the foregoing embodiments of the method. While the forementioned storage medium includes: various mediums that can store program codes such as ROM, RAM, magnetic disk or optical disk.

The device embodiments described above are only exemplary, wherein the units illustrated as separation parts may either be or not physically separated, and the parts displayed by units may either be or not physical units, i.e., the parts may either be located in the same plate, or be distributed on at least two network units. A part or all of the modules may be selected according to an actual requirement to achieve the objectives of the solutions in the embodiments. Those having ordinary skills in the art may understand and implement without going through creative work.

It should be finally noted that all the embodiments above are only configured to explain the technical solutions of the present disclosure, but are not intended to limit the protection scope of the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part or whole of technical features thereof, and these modifications or substitutions will not make the essence of the corresponding technical solutions depart from the spirit and scope of the claims.

### INDUSTRIAL APPLICABILITY

The video processing method, the video processing system, the video player and the cloud server of the present disclosure acquire the video information in the video corresponding to the selected human face picture in the video locating request, and display the video information corresponding to the selected human face picture through receiving the video locating request carrying the selected human face picture sent by the user through the man-machine interface module. The technical solution of the present disclosure may be employed to remedy the defect of low video locating efficiency in the prior art caused by that all the video segments of a certain determined human face cannot be located completely and implement to locate all the video information of a certain selected human face picture in the video, and has a very high video locating efficiency. Moreover, employing the technical solution of the present disclosure facilitates users to view the all the performances of an actor corresponding to the selected human face picture in the video, and the user experience degree is very good.

1. A video processing method, wherein the method comprises:
receiving a video locating request carrying a selected human face picture sent by a user through a man-machine interface module;
acquiring video information in a video corresponding to the selected human face picture in the video locating request, the video information comprising the identification of the selected human face picture and the information of at least one video segment of the selected human face picture; and
displaying the video information corresponding to the selected human face picture.

2. The method according to claim 1, wherein the acquiring the video information in the video corresponding to the selected human face picture in the video locating request comprises:
acquiring the video information corresponding to the selected human face picture from an established human face classification database.

3. The method according to claim 2, wherein the method, before the acquiring the video information corresponding to the selected human face picture from the established human face classification database, further comprises:
decoding each frame of video in the video and obtaining a group of images;
performing human face detection on each image in the group of images, and acquiring the human face in each image and the presentation time stamp of the human face;
generating a human face time stamp database according to the human face and the presentation time stamp of the human face;
classifying all the human faces in the human face time stamp database according to each human face identification, so that the human faces belonging to the same person correspond to the same human face identification;
estimating various types of the video segment information of the human face corresponding to the human face identification according to the presentation time stamp of the human face corresponding to each human face identification; and
establishing the human face classification database according to the various types of the video segment information corresponding to each human face identification.

4. The method according to claim 3, wherein the method, after the establishing the human face classification database according to the various types of the video segment information corresponding to each human face identification, further comprises:
sorting each human face identification in the human face classification database according to the probability of appearance in the video in a descending order.

5. The method according to claim 4, wherein the method, after the sorting each human face identification in the human face classification database according to the probability of appearance in the video in a descending order and before receiving the video locating request carrying the selected human face picture sent by the user through the man-machine interface module, further comprises:
displaying the top N human face identifications in the human face classification database, the N being an integer more than or equal to 1; and
further, the selected human face picture being selected by the user from the human face pictures corresponding to the N human face identifications; or the selected human face picture being inputted by the user through the man-machine interface module.

6. The method according to claim 3, wherein the method, after the establishing the human face classification database, further comprises:
sending the human face classification database to a cloud server; and
wherein the acquiring the video information in the video corresponding to the selected human face picture in the video locating request comprises:
sending the video locating request carrying the selected human face picture to the cloud server; and
receiving the video information sent by the cloud server, the video information being acquired by the cloud server from the human face classification database established in the cloud server according to the selected human face picture.
database established

7. A video player, comprising:
at least one processor; and
a memory communicably connected with the at least one processor for storing instructions executable by the at least one processor, wherein execution of the instructions by the at least one processor causes the at least one processor to:
receive a video locating request carrying a selected human face picture sent by a user through a man-machine interface module;
acquire video information in a video corresponding to the selected human face picture in the video locating request, the video information comprising the identification of the selected human face picture and the information of at least one video segment of the selected human face picture; and
display the video information corresponding to the selected human face picture.

8. The video player according to claim 7, wherein the acquiring the video information in the video corresponding to the selected human face picture in the video locating request comprises:
acquiring the video information corresponding to the selected human face picture from an established human face classification database.

9. The video player according to claim 8, wherein before the acquiring the video information corresponding to the selected human face picture from the established human face classification database, the at least one processor is further caused to:
decode each frame of video in the video and obtaining a group of images;
perform human face detection on each image in the group of images, and acquiring the human face in each image and the presentation time stamp of the human face;
generate a human face time stamp database according to the human face and the presentation time stamp of the human face;
classify all the human faces in the human face time stamp database according to each human face identification, so that the human faces belonging to the same person correspond to the same human face identification;
estimate various types of the video segment information of the human face corresponding to the human face identification according to the presentation time stamp of the human face corresponding to each human face identification; and
establish the human face classification database according to the various types of the video segment information corresponding to each human face identification.

10. The video player according to claim 9, wherein after the establishing the human face classification database according to the various types of the video segment information corresponding to each human face identification, the at least one processor is further caused to:
sort each human face identification in the human face classification database according to the probability of appearance in the video in a descending order.

11. The video player according to claim 10, wherein after the sorting each human face identification in the human face classification database according to the probability of appearance in the video in a descending order and before receiving the video locating request carrying the selected human face picture sent by the user through the man-machine interface module, the at least one processor is further caused to:
display the top N human face identifications in the human face classification database, the N being an integer more than or equal to 1; and
further, the selected human face picture being selected by the user from the human face pictures corresponding to the N human face identifications; or the selected human face picture being inputted by the user through the man-machine interface module.

12. The video player according to claim 9, wherein after the establishing the human face classification database, the at least one processor is further caused to:
sending the human face classification database to a cloud server; and
wherein the acquiring the video information in the video corresponding to the selected human face picture in the video locating request comprises:
sending the video locating request carrying the selected human face picture to the cloud server; and
receiving the video information sent by the cloud server, the video information being acquired by the cloud server from the human face classification database established in the cloud server according to the selected human face picture.

13. A cloud server, comprising:
at least one processor; and
a memory communicably connected with the at least one processor for storing instructions executable by the at least one processor, wherein execution of the instructions by the at least one processor causes the at least one processor to:
receive a video locating request carrying a selected human face picture sent by a video player, the video locating request being sent by a user through a man-machine interface module and received by the video player;
acquire the video information corresponding to the selected human face picture from a established human face classification database, the video information comprising the identification of the selected human face picture and the information of at least one video segment of the selected human face picture; and
send the video information corresponding to the selected human face picture to the video player for the video player to display the video information corresponding to the selected human face picture to the user.

14. The cloud server according to claim 13, wherein before the acquiring the video information corresponding to the selected human face picture from the established human face classification database, the at least one processor is further caused to:
establish the human face classification database.

15. The cloud server according to claim 14, wherein the establishing the human face classification database particularly comprises:
decoding each frame of video in the video and obtaining a group of images;
performing human face detection on each image in the group of images, and acquiring the human face in each image and the presentation time stamp of the human face;
generating a human face time stamp database according to the human face and the presentation time stamp of the human face;
classifying all the human faces in the human face time stamp database according to each human face identification, so that the human faces belonging to the same person correspond to the same human face identification; and
estimating various segments of the video segment information of the human face corresponding to the human face identification according to the presentation time stamp of the human face corresponding to each human face identification; and establishing the human face classification database according to the various segments of the video segment information corresponding to each human face identification.

16. The cloud server according to claim 15, wherein after the establishing the human face classification database according to the various segments of the video segment information corresponding to each human face identification, the at least one processor is further caused to:
sort each human face identification in the human face classification database according to the probability of appearance in the video in a descending order.

17. The cloud server according to claim 16, wherein after the sorting each human face identification in the human face classification database according to the probability of appearance in the video in a descending order and before receiving the video locating request carrying the selected human face picture sent by the video player, the at least one processor is further caused to:
send the top N human face identifications in the human face classification database to the video player for the video player to display the top N human face identifications to the user, the N being an integer more than or equal to 1; and
further, the selected human face picture being selected by the user from the human face pictures corresponding to the N human face identifications; or the selected human face picture being inputted by the user through the man-machine interface module.

18. The cloud server according to claim 13, wherein before the acquiring the video information corresponding to the selected human face picture from the established human face classification database, the at least one processor is further caused to:
receive the human face classification database sent by the video player.

19. A non-transitory computer-readable storage medium storing executable instructions that, when executed by a video player, cause the video player to perform the method according to claim 1.
